(19) United States
(12) Patent Application Publication
(10) Pub. No.: US 2014/0178668 A1
(43) Pub. Date: Jun. 26, 2014

(54) Method for Manufacturing a Soft Foamed Assembly Which is Used as a Decorative Outer Layer

(71) Applicant: Chih-Wen Chiang, Taipei City (TW)

(72) Inventor: Chih-Wen Chiang, Taipei City (TW)

(21) Appl. No.: 13/721,179

(22) Filed: Dec. 20, 2012

(51) Int. Cl. B29C 44/06; B32B 3/26

(52) U.S. Cl. CPC B29C 44/06; B32B 3/26
USPC 428/319.3; 264/46.6

(57) ABSTRACT

A method for manufacturing a soft foamed assembly includes a first step of providing a mold having an interior formed with a predetermined die cavity, a second step of fixing a polyurethane (PU) synthetic skin in the die cavity of the mold, a third step of filling a polyurethane (PU) liquid substance into the die cavity of the mold, a fourth step of closing the die cavity of the mold, and a fifth step of foaming the PU liquid substance in the die cavity of the mold to form a soft foamed body which is combined with the PU synthetic skin so as to form a soft foamed assembly consisting of the soft foamed body and the PU synthetic skin. Thus, the soft foamed assembly is made easily and quickly.

### BACKGROUND OF THE INVENTION

1. Field of the Invention

The present invention relates to a method for manufacturing a composite foam and, more particularly, to a method for manufacturing a soft foamed assembly which is used as a decorative outer layer that is available for an interior decoration.

2. Description of the Related Art

An interior decoration technology includes using a wall decoration to embellish the wall of a house so as to enhance the outer appearance and aesthetic quality of the interior of the house. A conventional wall decoration structure comprises many parts such as woods, cloth, wall paper, refractory linings or the like to construct a decorative outer layer so as to upholster the wall of the house. However, the worker has to cut and trim each of the parts of the wall decoration structure and to bond or fasten each of the parts of the wall decoration structure to the wall, so that it takes much time and manual work to mount the conventional wall decoration structure to the wall of the house, thereby greatly increasing the time and cost of the interior decoration of the house.

### BRIEF SUMMARY OF THE INVENTION

In accordance with the present invention, there is provided a method for manufacturing a soft foamed assembly, comprising a first step of providing a mold having an interior formed with a predetermined die cavity, a second step of fixing a polyurethane (PU) synthetic skin in the die cavity of the mold, a third step of filling a polyurethane (PU) liquid substance into the die cavity of the mold, a fourth step of closing the die cavity of the mold, and a fifth step of foaming the PU liquid substance in the die cavity of the mold to form a soft foamed body which is combined with the PU synthetic skin so as to form a soft foamed assembly consisting of the soft foamed body and the PU synthetic skin. The PU liquid substance includes polyether polyols and methylene bisphenyl isocyanate which are mixed together.

In accordance with the present invention, there is also provided a soft foamed assembly, comprising a soft foamed body and a PU synthetic skin combined with the soft foamed body. The soft foamed body includes polyether polyols and methylene bisphenyl isocyanate which are mixed together. The PU synthetic skin encompasses a top face and a periphery of the soft foamed body.

According to the primary advantage of the present invention, the PU liquid substance is foamed in the die cavity of the mold to form a soft foamed body which is combined with the PU synthetic skin to construct the soft foamed assembly so that the soft foamed assembly is made easily and quickly, thereby greatly saving the time and cost of fabrication of the soft foamed assembly.

According to another advantage of the present invention, the PU material and the polyether polyols have the same feature so that the PU synthetic skin and the soft foamed body are combined together closely and tightly during the foaming process.

According to a further advantage of the present invention, the die cavity of the mold is previously formed with patterns or stripes so that the PU synthetic skin has predetermined patterns or stripes so as to enhance the outer appearance and aesthetic quality of the soft foamed assembly.

According to a further advantage of the present invention, the soft foamed assembly is available for interior decoration so that the soft foamed assembly can be used in wall plates, floor cushions, furniture and the like, thereby enhancing the versatility of the soft foamed assembly.

According to a further advantage of the present invention, the soft foamed assembly is made to have different shapes, such as square, rectangular, circular, triangular, diamond and the like, thereby enhancing the diversity of the soft foamed assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a mold for manufacturing a soft foamed assembly in accordance with the preferred embodiment of the present invention.

FIG. 2 is a perspective opened view of the mold as shown in FIG. 1 in use.

FIGS. 3-8 are front cross-sectional views showing the forming process of the soft foamed assembly in accordance with the preferred embodiment of the present invention.

FIG. 9 is a perspective cross-sectional view of a soft foamed assembly in accordance with the preferred embodiment of the present invention.

FIG. 10 is a perspective view of a mold for manufacturing a soft foamed assembly in accordance with another preferred embodiment of the present invention.

FIG. 11 is a perspective opened view of the mold as shown in FIG. 10 in use.

FIGS. 12-17 are front cross-sectional views showing the forming process of the soft foamed assembly in accordance with another preferred embodiment of the present invention.

FIG. 18 is a perspective cross-sectional view of a soft foamed assembly in accordance with another preferred embodiment of the present invention.

### DETAILED DESCRIPTION OF THE INVENTION

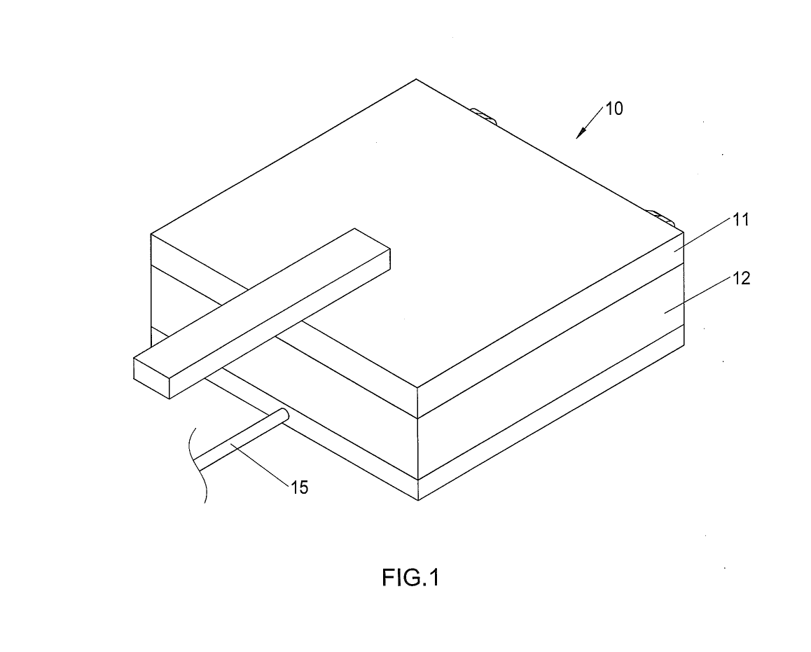

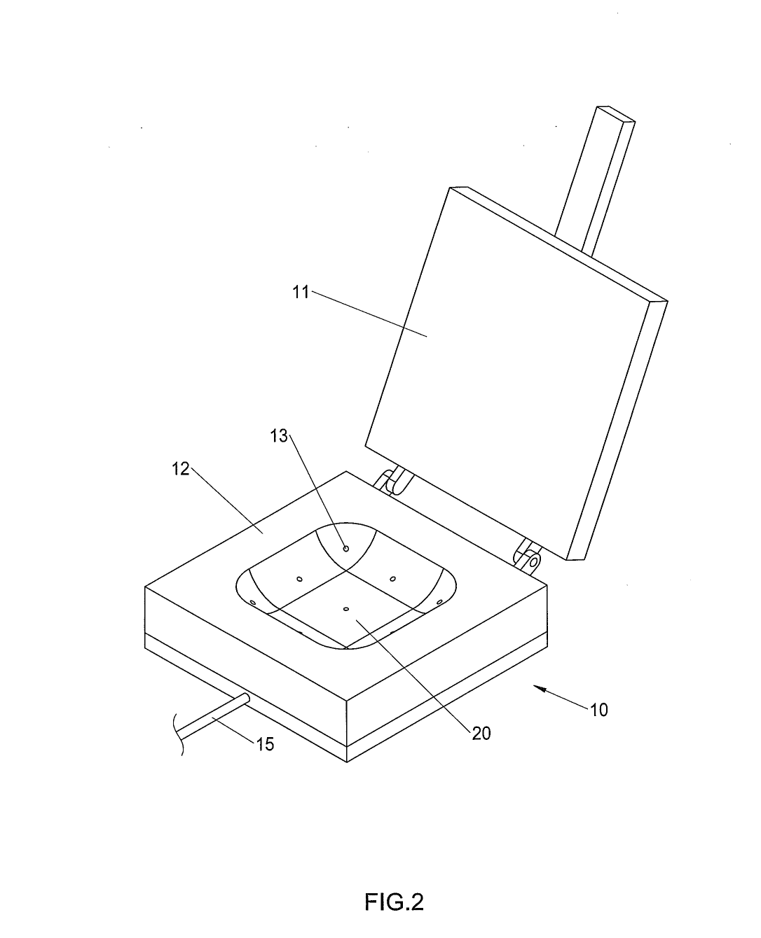

Referring to the drawings and initially to FIGS. 1-9, a method for manufacturing a soft foamed assembly in accordance with the preferred embodiment of the present invention comprises a first step of providing a mold 10 having an interior formed with a predetermined die cavity 20, a second step of fixing a polyurethane (PU) synthetic skin 40 in the die cavity 20 of the mold 10, a third step of filling a polyurethane (PU) liquid substance 50 into the die cavity 20 of the mold 10, a fourth step of closing the die cavity 20 of the mold 10, and a fifth step of foaming the PU liquid substance 50 in the die cavity 20 of the mold 10 to form a soft foamed body 30 which is combined with the PU synthetic skin 40 so as to form a soft foamed assembly consisting of the soft foamed body 30 and the PU synthetic skin 40.

In the preferred embodiment of the present invention, the mold 10 includes an upper die 11 and a lower die 12 pivotally connected with the upper die 11. The lower die 12 of the mold 10 has an interior formed with the die cavity 20. The mold 10 is operated at a working temperature that is controlled between thirty and forty degrees of centigrade (30-40° C.). The die cavity 20 of the mold 10 has a surface directly formed with predetermined patterns or stripes. The mold 10 has a bottom formed with a receiving space 14. The die cavity 20 of the mold 10 has a shape matching that of the soft foamed body 30.

The die cavity 20 of the mold 10 has a bottom formed with a plurality of air holes 13 each connected to the receiving space 14 of the mold 10. A connecting pipe 15 is located outside of the mold 10 and has a first end connected to the receiving space 14 of the mold 10 and a second end connected to an air extraction equipment (not shown). The PU liquid substance 50 includes polyether polyols and methylene bisphenyl isocyanate which are mixed together.

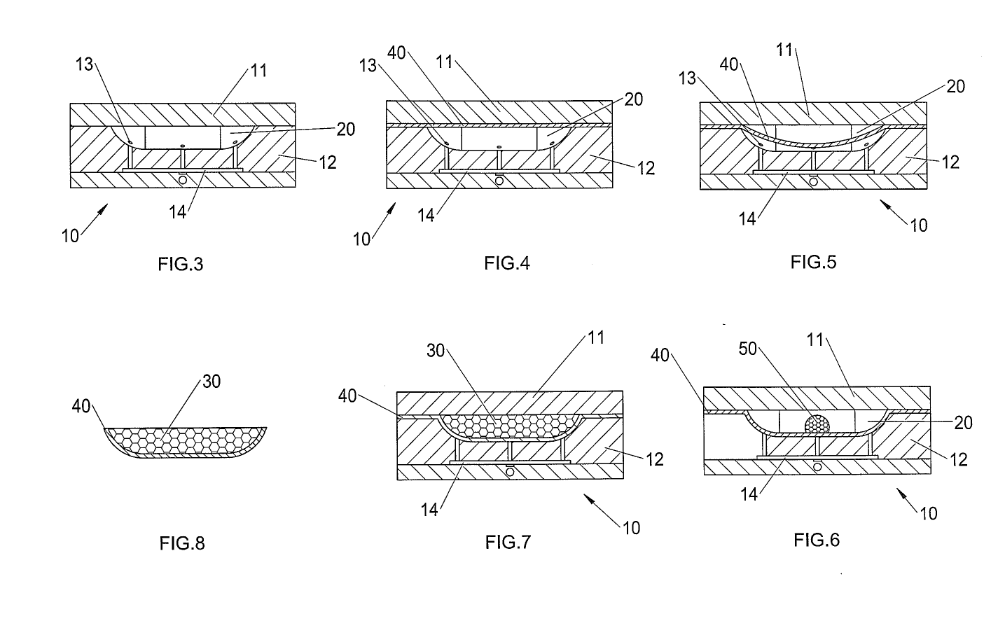

In fabrication, the upper die 11 is removed from the lower die 12 to open the mold 10 as shown in FIG. 3. Then, the PU synthetic skin 40 is placed in the die cavity 20 of the mold 10 as shown in FIG. 4. At this time, the PU synthetic skin 40 rests on the top face of the lower die 12. Then, the air extraction equipment is operated to provide an air extraction force which extends through the connecting pipe 15, the receiving space 14 and the air holes 13 into the die cavity 20 of the mold 10 so that the air in the die cavity 20 of the mold 10 produces a suction force to draw the PU synthetic skin 40. In such a manner, the PU synthetic skin 40 is drawn by the suction force from the air extraction equipment and is slightly bent toward the lower die 12 of the mold 10 as shown in FIG. 5 so that the PU synthetic skin 40 is positioned in the die cavity 20 of the mold 10. Then, the PU liquid substance 50 is filled into the die cavity 20 of the mold 10 as shown in FIG. 6. Then, the upper die 11 is moved toward the lower die 12 to close the mold 10 as shown in FIG. 7. Then, the air extraction equipment is operated again to provide a suction force to suck the air in the die cavity 20 of the mold 10 so that the air remaining in the die cavity 20 of the mold 10 is drawn through the air holes 13, the receiving space 14 and the connecting pipe 15 and is drained outward from the connecting pipe 15. Thus, the die cavity 20 of the mold 10 is disposed at a vacuum state. Then, the PU liquid substance 50 is foamed in the die cavity 20 of the mold 10 to form a soft foamed body 30 as shown in FIG. 7. In such a manner, the soft foamed body 30 is combined with the PU synthetic skin 40 so as to form a soft foamed assembly. At this time, the working temperature of the mold 10 is controlled between 30° C. and 40° C. so that the soft foamed body 30 is softer during the foaming process, and the soft foamed body 30 is combined with the PU synthetic skin 40 more closely and tightly. In addition, the die cavity 20 of the mold 10 is previously formed with predetermined patterns or stripes so that the PU synthetic skin 40 has predetermined patterns or stripes to enhance the outer appearance and aesthetic quality of the soft foamed assembly. Then, the upper die 11 is removed from the lower die 12 to open the mold 10. Then, the soft foamed assembly is removed from the mold 10. Finally, the rim of the PU synthetic skin 40 is cut and trimmed along the soft foamed body 30 to form a final product of the soft foamed assembly as shown in FIG. 8.

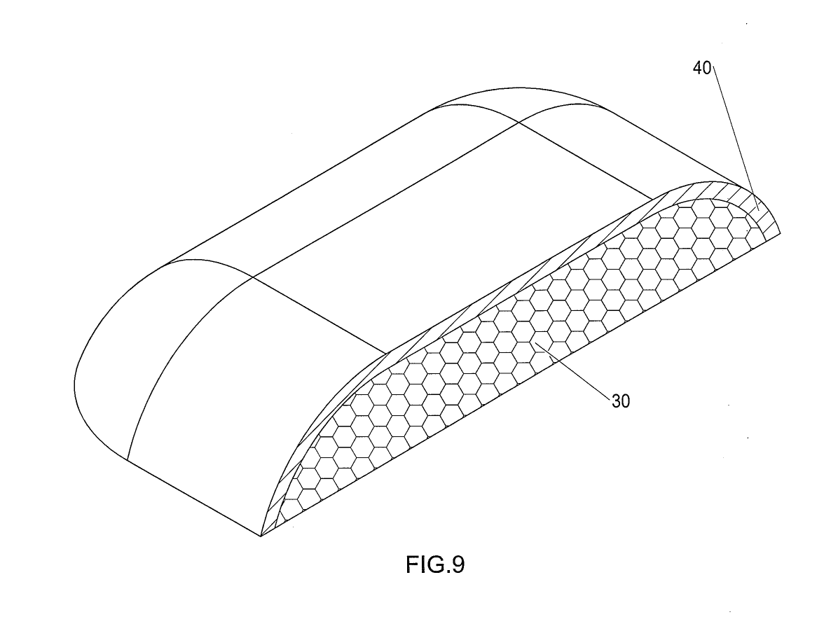

As shown in FIG. 9, the soft foamed assembly in accordance with the preferred embodiment of the present invention comprises a soft foamed body 30 and a PU synthetic skin 40 combined with the soft foamed body 30. The soft foamed body 30 includes polyether polyols and methylene bisphenyl isocyanate which are mixed together. The PU synthetic skin 40 encompasses a top face and a periphery of the soft foamed body 30.

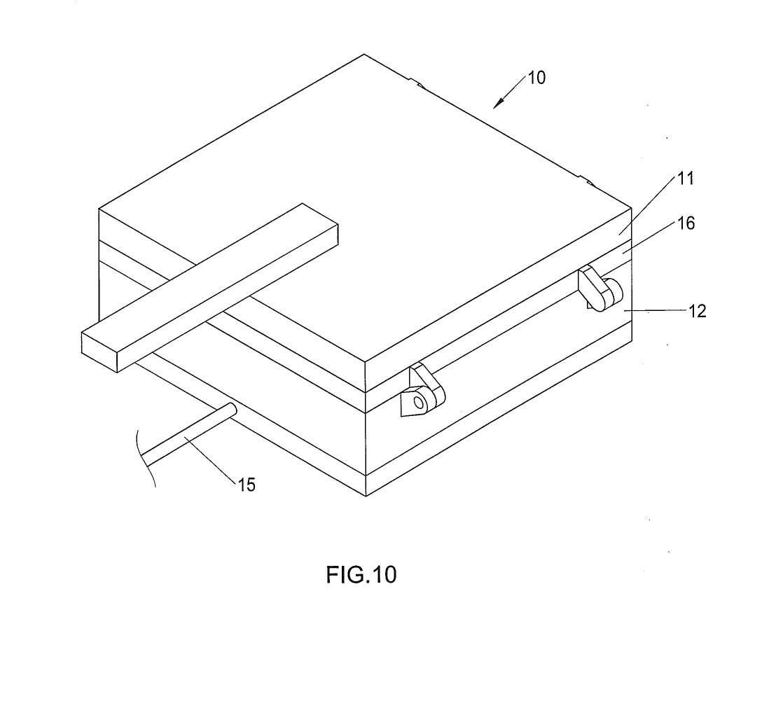

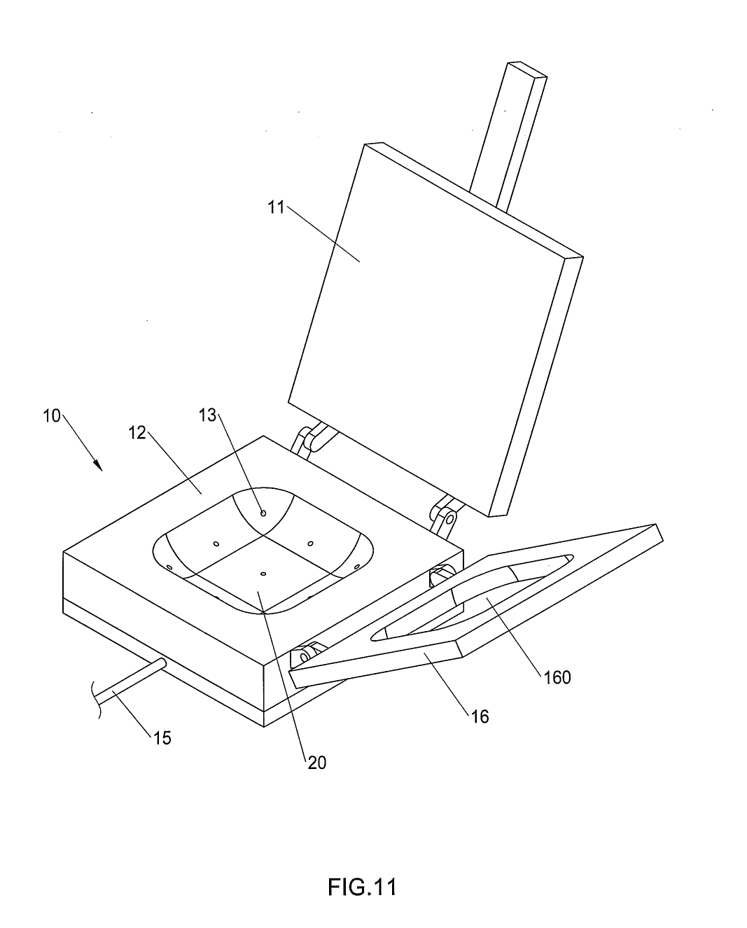

Referring to FIGS. 10-18, the mold 10 further includes an intermediate die 16 located between the upper die 11 and the lower die 12. The intermediate die 16 is pivotally connected with the lower die 12. The intermediate die 16 has an interior formed with an opening 160 which has a shape matching that of a top periphery of the die cavity 20.

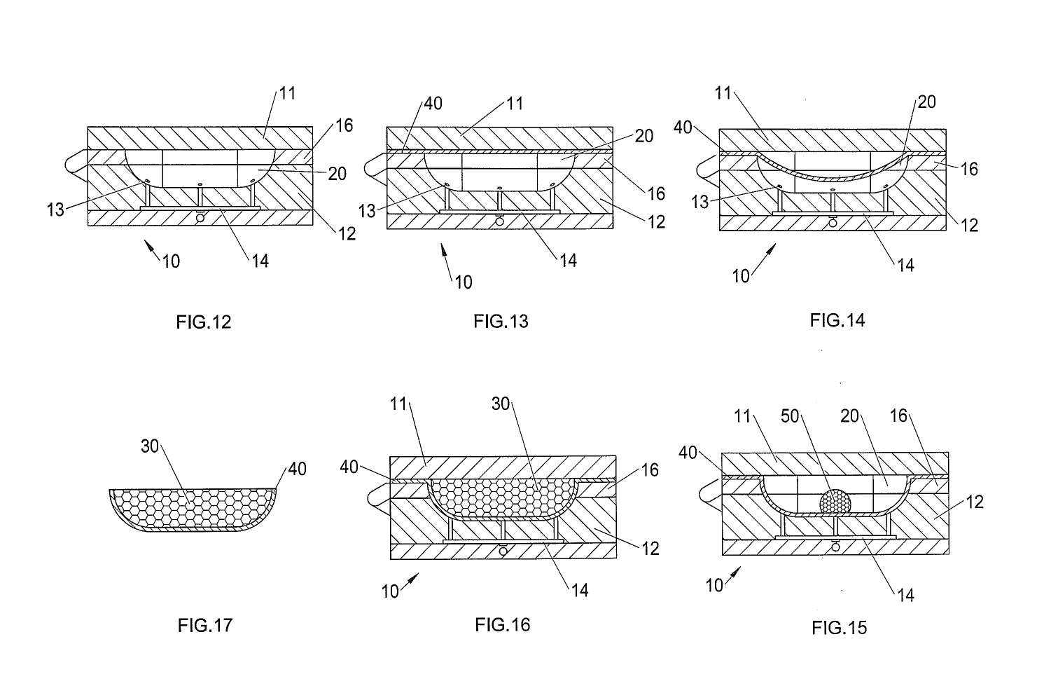

In fabrication, the upper die 11 is removed from the intermediate die 16 to open the mold 10 as shown in FIG. 12. Then, the PU synthetic skin 40 is placed in the die cavity 20 of the mold 10 as shown in FIG. 13. At this time, the PU synthetic skin 40 rests on the top face of the intermediate die 16. Then, the air extraction equipment is operated to provide an air extraction force which extends through the connecting pipe 15, the receiving space 14 and the air holes 13 into the die cavity 20 of the mold 10 so that the air in the die cavity 20 of the mold 10 produces a suction force to draw the PU synthetic skin 40. In such a manner, the PU synthetic skin 40 is drawn by the suction force from the air extraction equipment and is slightly bent toward the lower die 12 of the mold 10 as shown in FIG. 14 so that the PU synthetic skin 40 is positioned in the die cavity 20 of the mold 10. Then, the PU liquid substance 50 is filled into the die cavity 20 of the mold 10 as shown in FIG. 15. Then, the upper die 11 is moved toward the intermediate die 16 to close the mold 10 as shown in FIG. 16. Then, the air extraction equipment is operated again to provide a suction force to suck the air in the die cavity 20 of the mold 10 so that the air remaining in the die cavity 20 of the mold 10 is drawn through the air holes 13, the receiving space 14 and the connecting pipe 15 and is drained outward from the connecting pipe 15. Thus, the die cavity 20 of the mold 10 is disposed at a vacuum state. Then, the PU liquid substance 50 is foamed in the die cavity 20 of the mold 10 to form a soft foamed body 30 as shown in FIG. 16. In such a manner, the soft foamed body 30 is combined with the PU synthetic skin 40 so as to form a soft foamed assembly. At this time, the working temperature of the mold 10 is controlled between 30° C. and 40° C. so that the soft foamed body 30 is softer during the foaming process, and the soft foamed body 30 is combined with the PU synthetic skin 40 more closely and tightly. In addition, the die cavity 20 of the mold 10 is previously formed with predetermined patterns or stripes so that the PU synthetic skin 40 has predetermined patterns or stripes to enhance the outer appearance and aesthetic quality of the soft foamed assembly. Then, the upper die 11 is removed from the intermediate die 16 to open the mold 10. Then, the soft foamed assembly is removed from the mold 10. Finally, the rim of the PU synthetic skin 40 is cut and trimmed along the soft foamed body 30 to form a final product of the soft foamed assembly as shown in FIG. 17. In such a manner, the thickness of the soft foamed body 30 is increased by provision of the intermediate die 16.

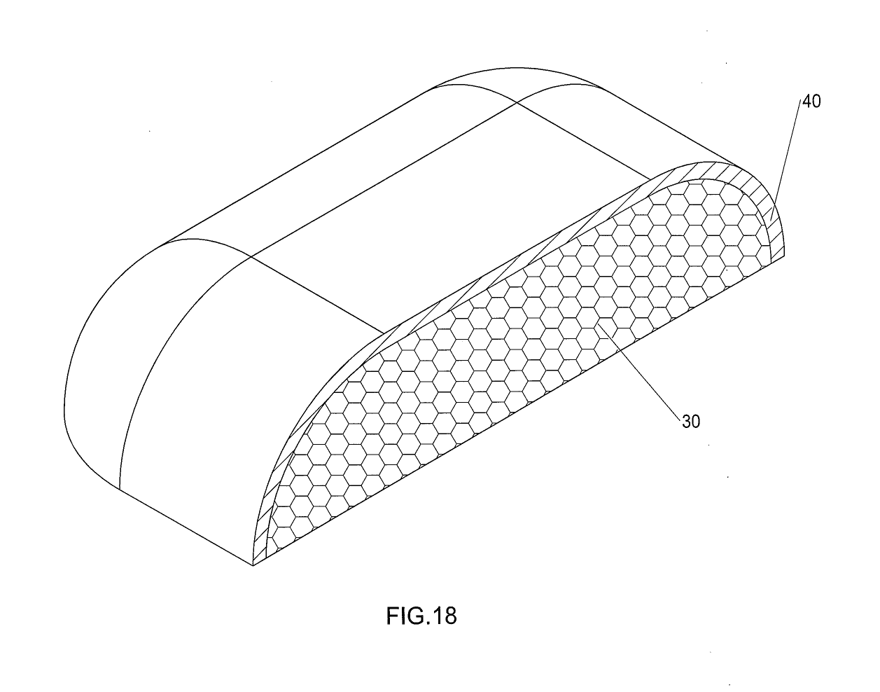

As shown in FIG. 18, the soft foamed assembly in accordance with the preferred embodiment of the present invention comprises a soft foamed body 30 and a PU synthetic skin 40 combined with the soft foamed body 30. The soft foamed body 30 includes polyether polyols and methylene bisphenyl isocyanate which are mixed together. The PU synthetic skin 40 encompasses a top face and a periphery of the soft foamed body 30.

Accordingly, the PU liquid substance 50 is foamed in the die cavity 20 of the mold 10 to form a soft foamed body 30 which is combined with the PU synthetic skin 40 to construct the soft foamed assembly so that the soft foamed assembly is made easily and quickly, thereby greatly saving the time and cost of fabrication of the soft foamed assembly. In addition, the PU material and the polyether polyols have the same feature so that the PU synthetic skin 40 and the soft foamed body 30 are combined together closely and tightly during the foaming process. Further, the die cavity 20 of the mold 10 is previously formed with patterns or stripes so that the PU synthetic skin 40 has predetermined patterns or stripes so as to enhance the outer appearance and aesthetic quality of the soft foamed assembly. Further, the soft foamed assembly is available for interior decoration so that the soft foamed assembly can be used in wall plates, floor cushions, furniture and the like, thereby enhancing the versatility of the soft foamed assembly. Further, the soft foamed assembly is made to have different shapes, such as square, rectangular, circular, triangular, diamond and the like, thereby enhancing the diversity of the soft foamed assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for manufacturing a soft foamed assembly, comprising:
a first step of providing a mold having an interior formed with a predetermined die cavity;
a second step of fixing a polyurethane (PU) synthetic skin in the die cavity of the mold;
a third step of filling a polyurethane (PU) liquid substance into the die cavity of the mold;
a fourth step of closing the die cavity of the mold; and
a fifth step of foaming the PU liquid substance in the die cavity of the mold to form a soft foamed body which is combined with the PU synthetic skin so as to form a soft foamed assembly consisting of the soft foamed body and the PU synthetic skin.

2. The method for manufacturing a soft foamed assembly of claim 1, wherein the mold includes an upper die and a lower die pivotally connected with the upper die, and the lower die of the mold has an interior formed with the die cavity.

3. The method for manufacturing a soft foamed assembly of claim 1, wherein the die cavity of the mold has a surface directly formed with predetermined patterns or stripes and has a shape matching that of the soft foamed body.

4. The method for manufacturing a soft foamed assembly of claim 1, wherein the mold is operated at a working temperature that is controlled between thirty and forty degrees of centigrade (30-40° C.).

5. The method for manufacturing a soft foamed assembly of claim 1, wherein:
the mold has a bottom formed with a receiving space;
the die cavity of the mold has a bottom formed with a plurality of air holes each connected to the receiving space of the mold; and
a connecting pipe is located outside of the mold and has a first end connected to the receiving space of the mold and a second end connected to an air extraction equipment.

6. The method for manufacturing a soft foamed assembly of claim 1, wherein the PU liquid substance includes polyether polyols and methylene bisphenyl isocyanate which are mixed together.

7. The method for manufacturing a soft foamed assembly of claim 2, wherein:
the mold further includes an intermediate die located between the upper die and the lower die;
the intermediate die is pivotally connected with the lower die; and
the intermediate die has an interior formed with an opening which has a shape matching that of a top periphery of the die cavity.

8. A soft foamed assembly, comprising:
a soft foamed body; and
a PU synthetic skin combined with the soft foamed body; wherein:
the soft foamed body includes polyether polyols and methylene bisphenyl isocyanate which are mixed together; and
the PU synthetic skin encompasses a top face and a periphery of the soft foamed body.
